(19) United States
(12) Patent Application Publication
(10) Pub. No.: US 2020/0197256 A1
(43) Pub. Date: Jun. 25, 2020

(54) MASSAGE DEVICE PROVIDED WITH AT LEAST ONE COSMETIC, DERMATOLOGICAL AND/OR PHARMACEUTICAL COMPOSITION

(71) Applicant: SEB S.A., Ecully (FR)

(72) Inventor: Franck MANDICA, Francheville (FR)

(21) Appl. No.: 15/753,625

(22) PCT Filed: Aug. 12, 2016
(86) PCT No.: PCT/FR2016/052075

§ 371 Date: Feb. 20, 2018

(30) Foreign Application Priority Data
Aug. 18, 2015 (FR) 1557795

(51) Int. Cl. A61H 15/02; A45D 34/04; A61H 15/00

(52) U.S. Cl. CPC A61H 15/02; A45D 34/041; A61H 2201/105; A61H 2015/0042; A61H 2015/0064; A61H 15/0085

(57) ABSTRACT

A massage device includes a massage head including massaging devices movable in rotation relative to the massage head and arranged so as to be in contact with an external body surface of a user; and, a casing carrying the massage head and including a drive system to activate the massaging devices. At least one of the massaging devices is filled with or stores a cosmetic, dermatological and/or pharmaceutical composition such that, during use, it applies the composition to the external body surface and massages the external body surface simultaneously.

### 1. FIELD OF THE INVENTION

The invention concerns the field of devices for treatment of an external body surface. The device according to the invention makes it possible, at the least, to massage the external body surface in order to give it tonicity. The massage device according to the invention will find its application among users who wish to care for their appearance by recontouring, firming and rejuvenating a body surface such as the skin of the face.

### 2. PRIOR ART

Massage devices comprising a massage head comprising massaging means that are mobile in rotation relative to the massage head and are arranged so as to be in contact with an external body surface of a user, and a casing equipped with drive means activating the massaging means, are known. Such massage devices are known from the patent documents FR 3012034 and FR 3012035.

However, one of the problems related to these massage devices is the fact that when the user wishes to combine the action of a cosmetic, dermatological, and/or pharmaceutical composition in order to treat a problem of hydration, recontouring, anti-aging, acne, etc., in combination with the massage device, the user must first apply a layer of the said composition on the external body surface. The layer of the composition spread on in advance may dry while the user applies the massage device on the body surface. When the composition has dried, or the massage means are used while dry on the external body surface, the massaging means may encounter difficulties moving on the body surface, thus causing a feeling of discomfort.

There are also cosmetic composition applicators comprising a reservoir containing the composition and a steel or plastic spherical ball housed in the application head which is fixed to the reservoir. Clearance is provided between the ball and the application head, such that the ball can turn freely on itself when it moves on the external body surface and withdraw a quantity of the composition in the application head in fluid communication with the reservoir in order to spread it on the external body surface. An applicator example is described in the document U.S. Pat. No. 4,940,350.

However, this type of applicator does not permit massaging the body surface sufficiently to permit the composition to penetrate the body surface and increase the mechanical action of the ball. In addition, a deposit of the composition may accumulate in the location of the clearance provided between the ball and the application head, which may prevent the rotation of the ball. In addition, the applicator has a rather limited application surface area because there is only one ball, and therefore it can treat only small areas of the external body surface.

In the document U.S. Pat. No. 3,436,161, a cosmetic composition applicator is described that comprises a handle with a roller rotating relative to the latter. The roller comprises a deformable external covering equipped with passages that each lead to a cavity in the surface of the covering. Inside the roller are arranged a reservoir containing the cosmetic composition and a measuring device to permit extracting doses of the composition from the reservoir and distributing them in the cavities, such that when the roller moves over a user's body surface, the covering deforms in contact with the body surface in order to permit the doses of the composition received in the cavities to spread on the body surface.

However, the layout of this applicator is complex. In addition, such an applicator permits applying a dose/quantity of cosmetic composition on the external body surface but does not permit a massage that would allow the composition to penetrate the body surface.

### 3. OBJECTIVES OF THE INVENTION

In particular, the invention aims to remedy all or a portion of the drawbacks of the prior art.

One objective of the invention is to provide a massage device facilitating the penetration of a cosmetic composition through a user's body surface by combining the massage action with the simultaneous distribution of a cosmetic, dermatological, and/or pharmaceutical composition on the external body surface, while being simple and compact.

### 4. SUMMARY OF THE INVENTION

These objectives are achieved thanks to a massage device comprising:
a massage head comprising massaging means that are mobile in rotation relative to the massage head and are arranged so as to be in contact with an external body surface of a user;
and,
a casing carrying the massage head and comprising drive means activating the massage means;
at least one of the massaging means is filled with or stores a cosmetic, dermatological, and/or pharmaceutical composition such that, during use, it applies the said composition on the external body surface and simultaneously massages the said external body surface in accordance with the mechanical stimuli desired on the skin.

This solution permits solving the aforementioned problems. In particular, the massage device combines a massage of the external body surface with an application/distribution of the cosmetic, dermatological, and/or pharmaceutical composition on the user's external body surface. The application of the composition simultaneously with the massage of the body surface permits facilitating the penetration of the composition, increasing the mechanical action, facilitating the movement of the massaging means on the skin because of the lubrication between the massaging means and the external body surface, and a uniform distribution of the composition on the external body surface.

According to a characteristic of the invention, the massaging means are removable from the massage head. Such a configuration permits easily replacing the massaging means when the cosmetic, dermatological, and/or pharmaceutical composition contained by the latter is exhausted.

With the same goal, the massage device comprises a support removably fixed to the massage head and on which the massaging means are arranged.

According to another characteristic of the invention, the massaging means comprise a hollow wall defining an internal cavity arranged so as to contain the cosmetic, dermatological, and/or pharmaceutical composition.

According to a characteristic of the invention, the device comprises a porous material arranged in the cavity of the massaging means and having a lower porosity than the wall formed of a porous material. As a result, the composition is contained in the massaging means and is put into contact with the body surface via the pores of the wall. The diffusing porous wall is thus provided with a cavity. This cavity may directly contain the composition to be distributed or contain another low-density porous material in order to maximize the quantity of composition conveyed, and to control the flow diffused.

According to another characteristic of the invention, the massaging means comprise a wall covered with the cosmetic, dermatological, and/or pharmaceutical composition. As a result, the composition is in direct contact with the user's body surface.

According to yet another characteristic of the invention, the massaging means comprise a wall covered with a covering in a textile material with microcapsules which are arranged so as to contain the cosmetic, dermatological, and/or pharmaceutical composition. This configuration permits a gradual release of the composition by breakage of the microcapsules, while controlling the gentleness of the massage by the textile.

According to another characteristic of the invention, the massage device comprises a reservoir arranged so as to contain the cosmetic and/or dermatological and/or pharmaceutical composition. This configuration facilitates the packaging of the composition.

Advantageously but not exclusively, the reservoir is arranged in the cavity of the massaging means. This configuration optimizes the quantity of composition conveyed.

According to another characteristic of the invention, the reservoir is formed by an envelope with a flexible and deformable wall provided with a slot, the wall being arranged so as to conform to an internal surface of the cavity of the massaging means. The massaging means is then flexible and conformable to the contours of the face.

According to another characteristic of the invention, the device comprises an extraction mechanism configured to act on the reservoir in order to extract contents.

According to another characteristic of the invention, the wall of the massaging means is spherical, semi-spherical or cylindrical, depending on the type of massage to be reproduced.

According to another characteristic, the massaging means are mounted to move along at least one axis of rotation. This configuration also permits increasing the mechanical action of the massaging means on the body surface.

According to another characteristic of the invention, the device contains the cosmetic, dermatological, and/or pharmaceutical composition, which permits increasing the volume of composition conveyed.

### 5. LIST OF FIGURES

Other innovative characteristics and advantages will be seen in the following description, provided for reference and in no way restrictive, in reference to the attached drawings, in which:

FIG. 1 is a schematic cross section of a massage device according to a first embodiment of the invention;

FIGS. 2 to 4 are schematic cross-sectional views of different embodiment examples of a massaging means of a massage device according to the invention;

FIG. 5 illustrates a perspective view of another embodiment example of a massaging means of a massage device according to the invention;

FIG. 6 is a perspective and partial view of the massage head of the massage device according to FIG. 1;

FIGS. 7 and 8 illustrate, according to exploded views, an alternative of the embodiment illustrated in FIG. 6.

FIG. 9 represents a schematic cross section of the massage head according to the invention; and,

FIG. 10 represents a cross-sectional view of another embodiment of a massage device according to the invention.

FIGS. 11a and 11b represent an alternative to the massage device as illustrated in FIG. 10.

### 6. DETAILED DESCRIPTION

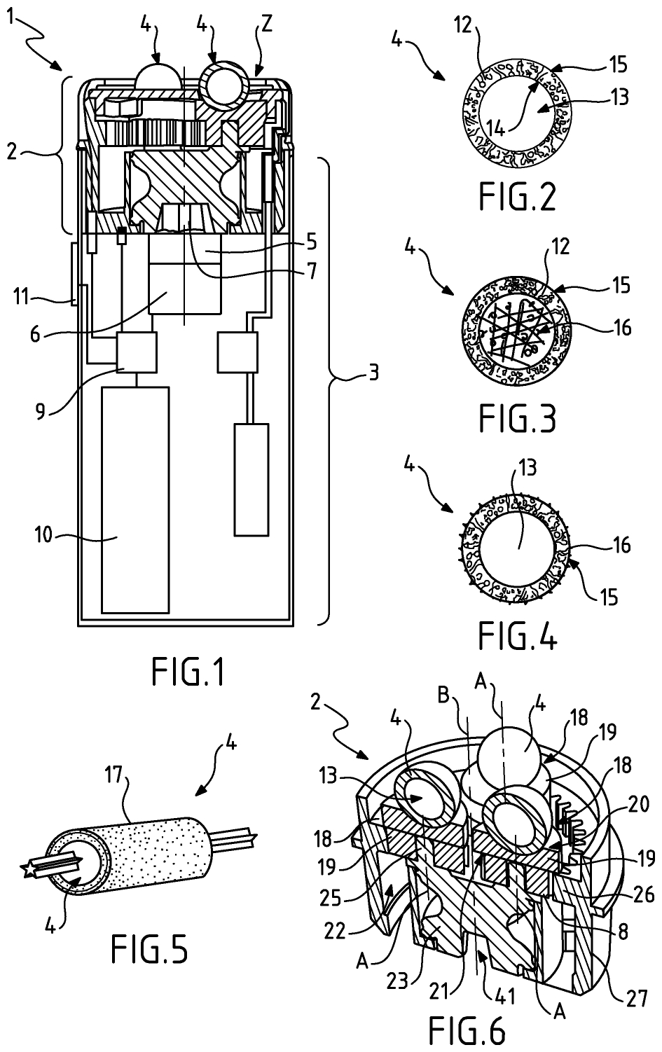

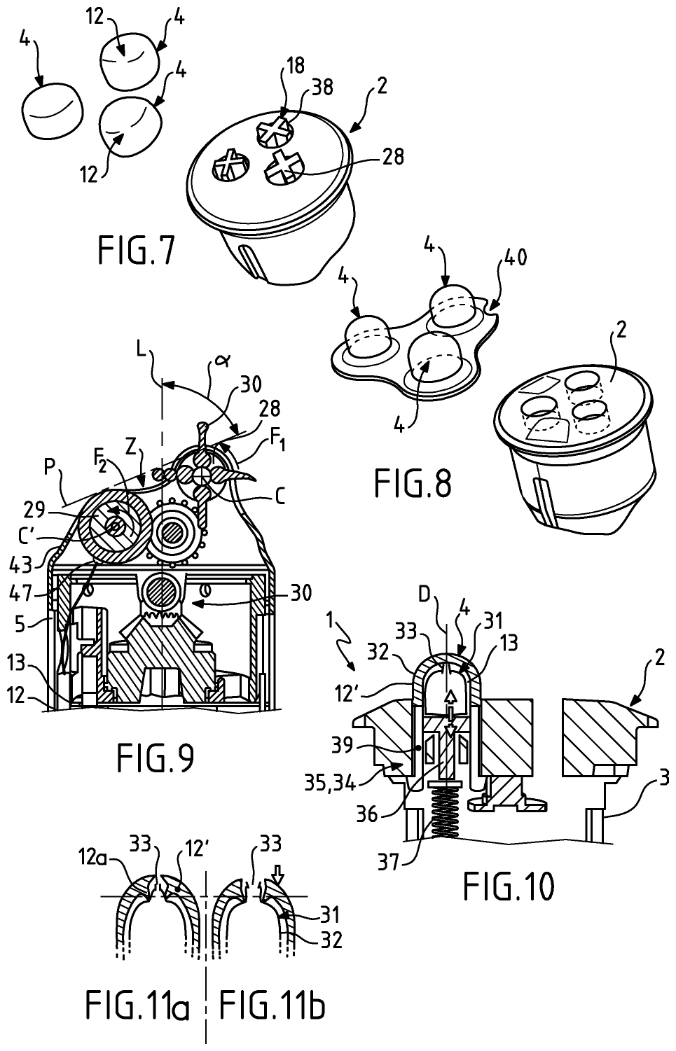

FIG. 1 illustrates a massage device 1 according to a first embodiment of the invention. The massage device 1 comprises a massage head 2 and a casing 3 carrying the massage head 2. The massage head 2 is removably mounted on the casing. The massage head comprises massaging means 4 that are mobile relative to the massage head 2. These massaging means 4 are arranged so as to be in contact with an external body surface of a user. Preferably, but not exclusively, the massaging means 4 are designed to exert a mechanical action on an external body surface, such as the skin on the face of a user.

To achieve this, the casing 3 comprises drive means 5 of the massaging means 4. The drive means 5 are activated, here, by an electric motor 6 which is housed inside the casing 3, and transmit the movement of the electric motor 6 to the massaging means 4. More specifically, the drive means 5 comprise a gearbox (not represented) driving an output shaft 7 arranged at one of the extremities of the casing 3 connecting to the massage head 2.

The electric motor 6 is controlled by a control unit 9 powered by a power supply means housed inside the casing 3. The power supply means here is a battery pack 10. Of course, the power supply means could be an adapter intended to be connected to an electricity network. The control unit 9 is in addition connected to a manual control interface 11 accessible from outside the casing. The manual control interface 11 may, for example, comprise an on/off switch and/or means for manual selection of operation programs.

According to the invention, the massaging means 4 are designed so as to work/massage the external body surface and simultaneously apply a cosmetic, dermatological, and/or pharmaceutical composition. The cosmetic, dermatological, and/or pharmaceutical composition presents hydrating, anti-wrinkle, anti-fatigue, anti-dark circle, anti-aging, anti-acne, anti-cellulite properties to permit brightening, recontouring, exfoliating, etc. The composition is in a more or less liquid form, a paste, or a solid at ambient temperature.

According to a characteristic of the invention, the massaging means 4 are arranged to be able to contain the cosmetic, dermatological, and/or pharmaceutical composition such that, during use, they apply the said composition and simultaneously massage the said external body surface. In this description, we understand the term “contain” in the expression “the massaging means are arranged to contain . . . ” to mean that the massaging means are filled with or store the cosmetic, dermatological, and/or pharmaceutical composition. In other words, the massaging means 4 are already supplied with composition before their activation and before they come into contact with the user's body surface.

For this purpose, in a first embodiment of the massaging means as illustrated in FIG. 2, the massaging means 4 have a hollow wall 12 defining an internal cavity 13. The latter is bounded by an internal surface 14 of the wall 12 which is opposite an external surface 15 intended to be in contact with the body surface. The internal cavity 13 is arranged so as to contain the cosmetic, dermatological, and/or pharmaceutical composition. The hollow wall 12 is then porous so as to permit the composition arranged in the internal cavity 13 to diffuse toward the body surface. In this description, we understand the term “porous” to mean a plurality of pores or openings going through the wall on both sides of the internal and external surface so as to establish a fluid communication between the internal cavity 13 of each massaging means 4 and the outside of the latter. The porous wall 12 is here made of a polymeric or organic material. The material is preferably, but not exclusively, chosen from the felt group—the material may be natural (animal hair, sphagnum, cotton, silica) or synthetic (PE/PET, aluminum foam). The wall 12 of the massaging means 4 has a thickness of between 0.5 and 1.5 mm in order to promote rapid circulation of the composition between the internal cavity 13 and the external surface 15 of the massaging means 4. In this embodiment, the composition is in liquid or more or less liquid form such that its pumping by the wall 12 is controlled according to the viscosity and surface tension of the composition.

According to an alternative of this embodiment of the aforementioned massaging means 4 which is illustrated in FIG. 3, an absorbent material is arranged in the internal cavity 13 of each massaging means. More specifically, this absorbent material comprises preferably, but not exclusively, a porous material 16 permitting storage of the composition inside the internal cavity 13. The porous material 16 is chosen from among PE/PET, rock wool, sphagnum, cotton, felt. The porous material 16 has a porosity of between 30 and 70%, ideally 50%. The diffusing material 12 is instead to be selected from among felt, aluminum foam or silica, and is hard (hardness>70 Shore A). The composition is then in a more or less liquid form and its viscosity is between 0.5 cP and 100 cP, preferably 50 cP.

According to another embodiment of the massaging means 4 illustrated in FIG. 4, the wall 12 of the massaging means 4 is arranged so as to be covered with the cosmetic, dermatological, and/or pharmaceutical composition. More specifically, the external surface 15 of the wall is composed of waxes, oils and fats, solid at ambient temperature. The hardness of the external surface 15 is then between 30 and 120 Shore A, preferably 80 Shore A. Thus, when the massaging means 4 work the body surface, the composition disposed on the external surface of the wall 12 is in direct contact with the body surface and is deposited by erosion/friction on the latter in order to coat it with the cosmetic, dermatological, and/or pharmaceutical composition. In this embodiment, the composition is preferably, but not exclusively, in solid form. The composition adheres better to the corresponding massaging means and permits maintaining its integrity. The deposition of the composition is also easier. The cosmetic, dermatological, and/or pharmaceutical composition also has the form of a layer with a thickness of between 0.5 and 5 mm.

According to an alternative of this embodiment illustrated in FIG. 4, the wall 12 of each massaging means 14 is covered with a covering 17 impregnated with the cosmetic, dermatological, and/or pharmaceutical composition. In this case, the covering 17 is a textile material with microcapsules containing the composition. Of course, the covering 17 may be chosen from the group comprising foams, sponges and other absorbent materials. The textile material may be woven or non-woven. The cosmetic, dermatological, and/or pharmaceutical composition is deposited by friction of the textile material when the massaging means 4 move on/work the user's external body surface.

Working the body surface is achieved by movement of the massaging means 4 against the body surface. The movement of the massaging means kneads or squeezes the body surface.

According to the embodiment illustrated in FIGS. 1 and 6, the massaging means 4 are removably mounted on the massage head 2 so that they can be replaced when the cosmetic, dermatological, and/or pharmaceutical composition to be applied is exhausted. Here, the massaging means 4 have a spherical or semi-spherical wall. In particular, the massaging means 4 comprise three balls which are each mobile in rotation in the massage head along an axis of rotation A parallel to each other. More specifically, the balls are each mounted on a work head 18 which comprises a disk 19 which is centered relative to the axis of rotation A. The disk 19 has an upper surface 20 on which the corresponding ball is rigidly connected to the disk 19. Each work head 18 further comprises a planetary gear 8 rigidly connected to a lower surface 21 of the corresponding disk 19, opposite the upper surface 20, and coaxial to the axis of rotation A. The massage head comprises control means 22 cooperating on one hand with the drive means 5, and on the other hand with the planetary gear 20. In particular, the control means 22 comprise a control shaft 23 of the axis B which comprises on a lower surface, a housing 41 to receive the output shaft, and on an upper surface, pins 25 each engaged in an axial bore of a planetary gear 8. The axis of rotation A of each ball is offset relative to the axis of the control shaft B. The control means 22 further comprise a fixed peripheral crown 26 rigidly connected to a case 27 constituting the massage head. Each of the planetary gears 8 meshes with the fixed peripheral crown 26 such that the rotation of the control shaft 23 results in movement of the balls. The balls have a diameter of between 5 and 15 mm. Preferably, but not exclusively, the diameter of each ball is 10 mm. The balls are filled with the cosmetic, dermatological, and/or pharmaceutical composition according to the embodiments illustrated in FIGS. 2 to 5.

According to an alternative to this embodiment illustrated in FIG. 7, each work head 18 comprises a base 38 whose cross section is in the shape of a cross. The wall 12 of the massaging means 4 is then semi-spherical and has a female recessed area so as to removably receive the male base 38 by interlocking or snap connection.

According to yet another alternative illustrated in FIG. 8, the massaging means 4 are mounted on a support 40 which is removably fixed to the massage head 2. In this case, the support 40 permits replacing the latter and the massaging means 4 when the composition is exhausted. Replacement is also possible in the event of deterioration of the support or of the massaging means. Each massaging means 4 in the form of a ball may be mounted on a plastic axle which itself is free to rotate. The axle may for example be orthogonal to the support plane 40. The massaging means 4 are therefore free to rotate during use.

According to another embodiment illustrated in FIG. 9, the massaging means 4 are removably mounted on the massage head 2 so that they can be replaced when the cosmetic, dermatological, and/or pharmaceutical composition to be applied is exhausted. The massaging means each have a cylindrical wall. In particular, the illustrated massaging means 4 comprise two cylindrical rollers which are each mobile in rotation on themselves around an axis of rotation C, C′. The axes of rotation C, C′ are parallel to each other. The two massage rollers, below called first roller 28 and second roller 29, are distant from each other and are separated by a work area Z which can be envisioned as adjustable or variable in a construction variant. According to an alternative of this embodiment that permits squeezing a portion of the body surface, the first massage roller 28 has at least one paddle 30 projecting radially from the surface of the first roller 28. Preferably, but not exclusively, the first roller 28 is provided with four paddles 30 distributed regularly at the periphery of the first roller. According to this alternative, the first massage roller 28 and the second roller 29 are arranged within the massage head such that a plane P, tangent to the first roller 28 and to the second roller 29 and situated toward the outside of the massage head, forms with an axis of the drive casing a non-zero angle different from a right angle. The first roller and/or the second roller are filled with the cosmetic, dermatological, and/or pharmaceutical composition according to the embodiments illustrated in FIGS. 2 to 5. The paddles 30 may also be covered with a layer of the cosmetic, dermatological, and/or pharmaceutical composition.

According to another embodiment of the invention illustrated in FIG. 10, the massaging means 4 are removably mounted in the massage head. Here, these have a semi-spherical wall 12′. In particular, the massaging means 4 comprise half-spheres or half-balls which are translationally mobile in the massage head 2 along an axis D which is here vertical in reference to FIG. 10. The massage head 1 comprises a reservoir 31 arranged so as to contain the cosmetic, dermatological, and/or pharmaceutical composition. In particular, the reservoir 31 is arranged in the internal cavity 13 of the wall 12′ of the massaging means 4. This reservoir 13 is formed of an envelope with a flexible and deformable wall 32. The latter conforms to the internal surface of the cavity 13 of the massaging means 4. The flexible wall 32 comprises a slot 33 permitting the composition in the reservoir to exit toward the wall 12′ of the massaging means 4, which is porous in this embodiment but may also be otherwise. According to a characteristic of this embodiment, the massage device comprises an extraction mechanism 34 configured to act on the reservoir 31 in order to extract its contents. The extraction mechanism 34 comprises a pump 35 cooperating with the reservoir 31. In particular, the pump 35 is installed in the massage head and in front of the reservoir 31 placed in the internal cavity of each massaging means 4. The pump 35 comprises a cylindrical body 39 and a piston 36 subject to the action of a spring 37 arranged in the casing 3. The cylindrical body 39 of the piston is snapped onto the corresponding massaging means 4. A pressure means is put into contact with the piston 36 to permit putting the reservoir 31 under pressure. During application, the skin rests on the wall 12′ which permits the opening of the slot 33 and the diffusion of the composition.

Alternatively to the embodiment illustrated in FIG. 10, and as visible in FIGS. 11a and 11b, the wall 12′ of the massaging means does not consist of a porous material but has an opening adjacent to the slot 33 of the reservoir. When the device is in a free state without pressure against the skin, the slot 33 of the reservoir 31 stays closed. The wall 12′ further presents support means 12a permitting the opening of the slot 33 as visible in FIG. 11b.

We will now describe the functioning of the massage device. The user applies the massage head of the massage device 1 against an external body surface to be worked, then the user turns the device on using the manual control interface 11. The massaging means 4, in this instance the balls or rollers, are activated in rotation by the drive means via the electric motor 6. The rotation of the balls or rollers permits massaging the external body surface of the user. Simultaneous with this massage, the cosmetic composition contained by the massaging means 4 is disposed on the external body surface either by release from the internal cavity 13 or by direct friction with the external body surface of the user. The choice of textures, viscosities and forms of distribution of the composition may thus be perfectly adapted to the massage (mechanical stimuli) chosen. In particular, this permits adjusting the massage and the penetration time of the composition in the skin. This also permits applying the cosmetic with the selected massage for greater efficiency and safety. The movement of the massaging means 4 is therefore facilitated, since the latter are lubricated and the penetration of the cosmetic, dermatological, and/or pharmaceutical composition is improved.

The invention is described in the preceding as an example. It is understood that those skilled in the art are able to carry out different embodiment variants of the invention, for example, by combining the various above characteristics taken alone or in combination, without departing from the context of the invention.

1. Massage device comprising:
a massage head comprising massaging means that are mobile in rotation relative to the massage head and are arranged so as to be in contact with an external body surface of a user; and,
a casing carrying the massage head and comprising drive means configured to activate the massaging means;
wherein at least one of the massaging means is filled with or stores a cosmetic, dermatological, and/or pharmaceutical composition such that, during use, the at least one massaging means applies the composition on the external body surface and simultaneously massages the external body surface.

2. The massage device according to claim 1, wherein the massaging means are removable from the massage head.

3. The massage device according to claim 2, further comprising a support removably fixed to the massage head and on which the massaging means are arranged.

4. The massage device according to claim 1, wherein the massaging means comprise a hollow wall defining an internal cavity arranged so as to contain the cosmetic, dermatological, and/or pharmaceutical composition.

5. The massage device according to claim 4, further comprising a porous material arranged in the internal cavity of the massaging means and having a lower porosity than the wall formed of a porous material.

6. The massage device according to claim 1, wherein the massaging means comprise a wall covered with the cosmetic, dermatological, and/or pharmaceutical composition.

7. The massage device according to claim 1, wherein the massaging means comprise a wall covered with a covering in textile material with microcapsules which are arranged so as to contain the cosmetic, dermatological, and/or pharmaceutical composition.

8. The massage device according to claim 1, further comprising a reservoir arranged so as to contain the cosmetic and/or dermatological and/or pharmaceutical composition.

9. The massage device according to claim 8, wherein the reservoir is arranged in the cavity of the massaging means.

10. The massage device according to claim 9, wherein the reservoir is formed by an envelope with a flexible and deformable wall provided with a slot, the wall being arranged so as to conform to an internal surface of the cavity of the massaging means.

11. The massage device according to claim 8, further comprising an extraction mechanism configured to act on the reservoir in order to extract contents.

12. The massage device according to claim 1, wherein the wall of the massaging means is spherical, semi-spherical or cylindrical.

13. The massage device according to claim 1, wherein the massaging means are mounted to move along at least one axis of rotation.

14. The massage device according to claim 1, wherein the massage device contains the cosmetic and/or dermatological and/or pharmaceutical composition.
